(19) United States
(12) Patent Application Publication
(10) Pub. No.: US 2012/0290847 A1
(43) Pub. Date: Nov. 15, 2012

(54) SYSTEM AND METHOD FOR RELIABLY PRESERVING WEB-BASED EVIDENCE

(75) Inventors: James P. O'CONNOR, Reston, VA (US); Thomas KLAFF, Reston, VA (US)

(73) Assignee: Surety, LLC, Reston, VA (US)

(21) Appl. No.: 13/103,699

(22) Filed: May 9, 2011

(51) Int. Cl. H04L 9/32

(52) U.S. Cl. 713/178; 713/150

(57) ABSTRACT

An evidence collection system for reliably collecting and preserving web-based evidence. An end-user's computing device browser accesses an evidence collection web site and identifies a web resource to be collected. An evidence collection station communicates with the target web server(s) and collects the body of evidence requested. Multiple representations of the information are collected to support the defensibility of the capture. Digital signature and digital time stamp methodologies are used to enhance the forensic soundness of the captured evidence. Capture results are conveyed to the end-user along with a report that describes the evidence captured in a manner which may be utilized as evidence comprehensible to a lay judge and jury.

### FIELD OF THE INVENTION

The invention generally relates to systems and methodologies for capturing Internet content. More particularly, the invention relates to systems and methodologies for reliably capturing and preserving web-based evidence in a forensically sound manner.

### BACKGROUND AND SUMMARY

With the ever growing popularity of social networking, there has been a massive explosion of content on the Internet. In the past, many Internet sites sponsored by corporate entities present content that has been relatively tightly controlled. Notwithstanding attempts by corporate entities to police webpage content, such content has nevertheless been used by adversaries in legal proceedings.

With the current massive participation in social networking, on such sites as Facebook, Twitter, and on a multitude of chat rooms, blogs, forums, and community feedback channels, the degree of control exercised in controlling what is posted on the Internet has diminished dramatically. It is well recognized that in a multitude of instances, Internet postings have been made by authors using extremely poor judgment. For example, individuals who participate in chat room conversations often experience commentary from participants that are extremely derogatory, inflammatory, and/or hurtful. Another example arises when a posting divulges information that is confidential and is controlled by a confidentiality agreement.

In many instances, in many diverse Internet forums, such derogatory commentary may be, for example, directed at a corporate business entity. Such derogatory comments may be blatantly false, without and factual basis, and extremely harmful to the business interest of the corporate entity. A corporate entity, whose business has been severely damaged by such commentary, may be of the view that 1) the individual involved need to stop making such injurious comments, and 2) the commentary has severely damaged the company's reputation and future business prospects, and 3) it deserves to be compensated for such damages through the legal process.

With the growth of content sharing sites such as YouTube and Flickr, eCommerce sites such as Amazon and iTunes, application distribution platforms, for example, the Apple App Store and the Android Market, file sharing services, web based source code repositories such as SourceForge and GitHub, and web-based e-mail applications such as Gmail, there are many instances where videos, music, photographs, applications, source code, emails, documents, and other content can be distributed that infringes on a corporate or individual intellectual property rights or is otherwise damaging.

The same problems exist when users submit and view web content through desktop applications that access Internet resources, but do not use a browser or use an embedded browser, for example, peer-to-peer file sharing applications such as BitTorrrent and LimeWire,

The problem also exists when Internet content is entered and accessed through mobile applications running on smartphones such as the iPhone or Android, or tablets such as the iPad. Twitter is a good example of an application that might run on a mobile device where the information disseminated may be damaging to others.

There are cases where information posted on a website could evidence in a criminal investigation, for example, fraud, drug, or terror-related postings; or where there is information that demonstrates a violation of a contractual obligation, for example, non-disclosure or non-compete agreement. It could be that content contradicts representations that an individual has made related to employment or insurance contracts.

If the offending individual is alerted by the company (the term company is used here, but this could also be an individual, a regulatory or law enforcement organization, or some other interested party) that the company has been damaged by such a posting, the offender will likely remove such content from the Internet. The ease with which information may be removed from the Internet may vary depending upon the website or application.

The difficulty then arises as to how an injured party can reliably prove that such content actually existed. One approach may be to simply print out a copy of the webpage containing the offending content. While an individual viewing content on a webpage may print the content, it may be difficult to legally establish that the printed out content was not contrived.

Likewise, if the content were saved to disk by the offended party, such saved content may be alleged by the offending party to have been edited by the offended entity. Further, allegations made contesting the authenticity of the captured information may be difficult to overcome, in part, in light of the fact that the information was not captured by a disinterested party.

The illustrative implementations provide the ability to capture such evidence in manner which is forensically sound, providing the ability to seek legal redress by, for example, a person who has been the subject of derogatory, defaming attacks. Likewise, the illustrative implementations may be advantageously utilized by an author, whose copyrighted work has been pirated and posted on the Internet. Further, the illustrative implementations may be utilized by governmental entities spotting evidence of possible illegal activities posted on social networking sites. Further, the illustrative implementations may be utilized to capture a wide range of strategic information appearing on the Internet including evidence of the creation of intellectual property created by the end-user or others.

In accordance with the illustrative implementations, as noted above, such web-based content including such strategic information/evidence is captured by a disinterested third party in a manner which is forensically sound.

In accordance with an illustrative implementation, a CEO, using a computing device browser, accesses a website that constitutes an evidence collection system for collecting a wide range of strategic information. Upon accessing the website, the CEO may, in this example, identify a webpage, such as a Facebook page, on which derogatory comments were posted that the CEO desires to have captured in a forensically sound manner. In communicating with the evidence collection system website, the CEO may specify the associated URL of the offensive webpage, together with any instructions that are required to access the webpage, such as any required password for accessing the site containing the offensive material.

In an illustrative implementation, the evidence collection system also includes an evidence collection station that collects the body of evidence posted on the Internet on a webpage at a target website such as Facebook, Yahoo, and/or Google, etc., using the forensically sound methodology described herein.

The evidence collection station saves the evidence embodied on at least such a webpage in a forensically sound manner. In accordance with an illustrative embodiment, the information is collected in multiple different ways. In accordance with an illustrative embodiment, the information is captured in, for example, three different ways as is explained in detail herein. In this fashion, it is established that the identified information did, in fact, appear on the Internet at the specified time. In an illustrative implementation, the image of the webpage is collected in rendered form as it would appear to someone who visited the website at that time. A second form of information captured is the information utilized to generate the page image, such as the webpage Hypertext Markup Language (HTML) markup, image files, scripts, stylesheets, and other information utilized to create the webpage image. Such underlying information is retrieved from the accessed website. Additionally, in an illustrative implementation, the system captures the network packets that were transmitted between the browser and the website while the page was being downloaded. This is a representation of the webpage as it appeared “on the wire”.

In an illustrative implementation, the system may apply a digital signature to the generated evidence to identify the party that collected the evidence and to protect the evidence from modification. In an illustrative implementation, the system may also apply a trusted time stamp to the evidence and the above signature to prove that captured Internet content and the signature existed in a certain form at a certain time and has not been changed since the identified time. Both of these measures add to the forensic strength of the generated evidence. In accordance with an illustrative optimum implementation, the system uses both a digital signature and digital time stamp methodologies to enhance the forensic soundness of the captured evidence.

Ultimately, a report is generated that documents and explains the collected and captured web-based evidence. The identified evidence which was packaged in a forensically sound manner is then conveyed along with the report to the end-user. In an illustrative implementation, the report generated describes the evidence captured in a manner which may be utilized as evidence comprehensible to a lay judge and jury.

Using the above-described system and methodology detailed herein, an end-user has the ability to collect and capture evidence that appears on the Internet in a manner which is forensically sound. Such methodology preserves evidence that otherwise is transient since it is subject to change and/or deletion from a particular website.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 is a block diagram depicting an illustrative system for reliably preserving web-based evidence in a manner that is forensically sound.

FIG. 2 is a block diagram of an illustrative implementation of the hardware associated with the evidence collection station shown in FIG. 1.

FIG. 3 is a block diagram of the evidence collection station functional/software architecture.

FIG. 4 delineates the sequence of operations performed by a scheduling and control module in capturing a set of web resources and producing a capture report.

FIG. 5 is a flowchart further depicting the processing performed by the scheduling and control module involved in capturing of a single web resource.

FIG. 6 is an example of the structure of the result of a web capture.

FIG. 7 is an illustration of the capture report components.

FIG. 8 is an illustrative visual representation of a website certificate.

FIG. 9 is an illustrative visual representation of the authenticity of secure time stamp and digital signature on a packet capture.

FIG. 10 is an illustrative visual representation of a secure time stamp.

FIG. 11 is an illustrative visual representation of a digital signature.

### DETAILED DESCRIPTION OF ILLUSTRATIVE IMPLEMENTATIONS

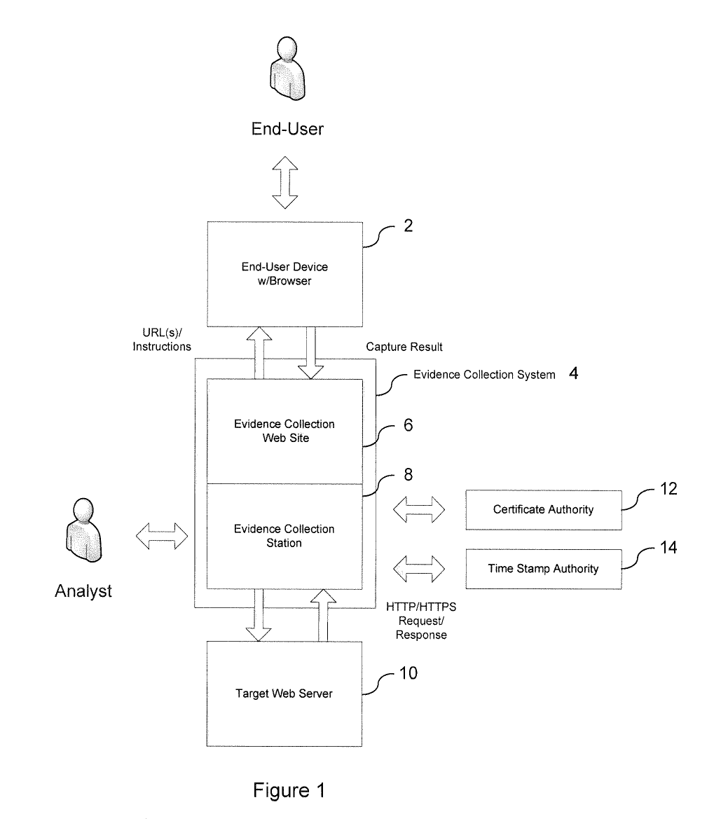

FIG. 1 is a block diagram depicting an illustrative system for reliably preserving web-based evidence in a manner that is forensically sound. Further, the illustrative implementations may be utilized to capture a wide range of strategic information appearing on the Internet including evidence of the creation of intellectual property created by the end-user or others.

The end-user shown in FIG. 1 may, for example, be a corporate CEO, whose corporation has been the target of false attacks at various social networking sites by various individuals employed by a corporate competitor.

The end-user device 2 may be, for example, the corporate CEO's desktop computer, any of the various commercially available smartphones, such as the Apple iPhone, a tablet computer, such as the Apple iPad, a laptop computer or any other computing device that includes a browser with connectivity to the Internet. In an illustrative implementation, the CEO accesses a website that constitutes evidence collection system 4 using the device 2 browser. Upon accessing the website, the CEO may, in this example, identify a webpage, such as a Facebook page, on which the derogatory comments were posted that the CEO desires to have captured in a forensically sound manner. In communicating with the evidence collection website 6, the CEO may specify the associated URL of the offensive webpage, together with any instructions that are required to access the webpage, such as any required password for accessing the site containing the offensive material.

In an illustrative implementation, the evidence collection website 6 is an Internet website that the end-user accesses via the end-user's computing device with browser 2 and places an order for capturing the offending content published on the Internet in a forensically sound manner. The evidence collection website 6 is implemented on a conventional computer system using conventional hardware and software involved in running a website as is well understood by those skilled in the art. Typically, an end-user specifies to the evidence collection website 6, the URL of the webpage on which the offending material is posted, together with an identification of the offending published material appearing on the webpage.

In the illustrative implementation of the evidence collection website, the end-user may have an account on the evidence collection website and must log into the account prior to the requesting the capture. In this case, the user would have gone through a previous registration process and made appropriate payment arrangements. For example, the user may have registered for a plan allowing for unlimited number of resource captures. As another example, the user may have signed up for a plan where the user's account is charged for each web resource capture requested. In another illustrative embodiment, the evidence collection website may require payment-related information to be entered by the end user at the time the request is made. This information would be transmitted to the evidence collection website in a secure manner, for example, using HTTPS.

As will be appreciated by those skilled in the art, the evidence collection web site 6 is a web application, running on a computer system, developed using a commercially available or open source web application framework, for example, Ruby on Rails. The site would operate using conventional web server, for example, Apache, and would use a conventional database management system, for example, MySQL.

In the illustrative implementation, the evidence collection web site and evidence collection station are independent computer systems. In an alternative illustrative implementation, these functions may be merged and delivered on a single computer system.

In another illustrative implementation, the evidence collection web site might be omitted all together, and the URL requests and associated information could come directly from the analyst, and results collected directly by the analyst. In this implementation, the analyst and the end-user may be one in the same.

The evidence collection system 4 also includes an evidence collection station 8 that collects the body of evidence and/or other strategic information posted on the Internet using the forensically sound methodology described herein.

The target web server 10 is the web server that contains the content and/or the links to additional content that the end-user may view, capture, and preserve in a forensically sound manner using the evidence collection system 4 in the manner described herein. As will be appreciated by those skilled in the art, the target web server 10 is a computer system running conventional software such as Microsoft IIS or Apache web software that delivers webpages. Thus, the target web server 10 may be, for example, a web server operated by Facebook, Yahoo, and/or Google, etc., on which the offending material is posted. The target web server 10 typically has associated databases (not shown) that store, for example, user content that may include derogatory materials that the end-user desires to capture in a forensically sound manner.

The evidence collection station 8 is comprised of a computer system running evidence collection software in response to receiving, inter alia, a set of one or more URL's. The evidence collection station 8, after receiving a first URL, accesses the target website 10 indicated by the URL and obtains and renders an image of the content on the webpage that the end-user has identified.

The evidence collection station 8 saves the evidence and/or other strategic information on at least such a webpage in a forensically sound manner. The identified evidence is packaged in a forensically sound manner and used to produce a report that is communicated to the end-user device 2. In an illustrative implementation, the report generated describes the evidence captured in a manner that may be utilized as evidence comprehensible to a lay judge and jury.

In an illustrative implementation, the evidence collection methodology is totally automated by the evidence collection station hardware and software 8. In alternative embodiments, an analyst may be utilized to perform certain forensic/clerical tasks that may vary from minimal involvement to considerable involvement depending upon the desired implementation, as will be appreciated by those skilled in the art. For example, the analyst may access the target web server 10 with an evidence station 8 browser and access a webpage containing offending material. The analyst may, for example, initiate the capture of the offending content by storing the offending webpage on the evidence station 8's disk in the manner described herein.

In an illustrative implementation, the analyst may be utilized to address evidence access issues that may, in certain circumstances, be challenging to simply automate in an error-free manner. The analyst may, for example, utilize instructions conveyed by the end-user that must be followed to appropriately log-in to a target web server website 10. The analyst may be, in such an example, given permission by the end-user to utilize the end-user's Facebook password to access the Facebook webpage where the end-user identified the false and damaging content. In an illustrative implementation, after the analyst appropriately logs-in, the evidence collection station's automatic capturing methodology may then be executed.

In other illustrative implementations, a URL may not be available for accessing a webpage. For example, it may be necessary to access a webpage and then follow certain instructions such as accessing a particular link in order to reach a location, such as a Facebook Wall containing the offensive material.

As shown in FIG. 1, in an illustrative implementation, the system utilizes a trusted time stamp authority 14. A trusted time-stamp allows the owner of a time-stamped document to prove that the document existed in a certain form at a certain time and has not been changed since the identified time. In an illustrative implementation, the linking-based time stamp methodology developed by the applicants' assignee Surety, LLC, is used. This methodology is described in U.S. Reissue No. 34,954, U.S. Pat. No. 5,373,561, and U.S. Pat. No. 5,781,629 which are incorporated herein by reference in its entirety. This technology is marketed by Surety LLC as the AbsoluteProof Service.

In an illustrative implementation, the system uses both digital signature and digital time stamp methodologies to enhance the forensic soundness of the captured evidence. Through digital signature methodology, the identity of the collecting party is bound to the collected evidence and to the report. As will be appreciated by those skilled in the art, if a recipient of the document changed the document, the digital signature associated with the document would not be verifiable. Using, for example, public key cryptography, a party generating the digital signature utilizes his or her private key to digitally sign such a document. A mathematically related public key is used to validate the digital signature. Such verification of the digital signature establishes that the person associated with the public key signed the document because only that person has the counterpart private key.

In an illustrative implementation, a certificate authority 12 such as, for example, VeriSign, asserts that a public key is, in fact, the public key of a particular signer and generates a digital attestation, known as a digital certificate, that includes the public key and an identification of the owner of the public key. The digital certificate is signed using the private key of the certificate authority, e.g., VeriSign. The digital signature, in combination with the corresponding digital certificate, adds to the forensic strength of the generated evidence.

In an illustrative implementation, a certificate authority 12 can also provide revocation information, for example a certificate revocation list (CRL) or Online Certificate Status Protocol (OCSP) response, related to the digital certificate corresponding to the private key used to sign the evidence. This revocation information is important in evaluating how much trust can be placed in the digital signature.

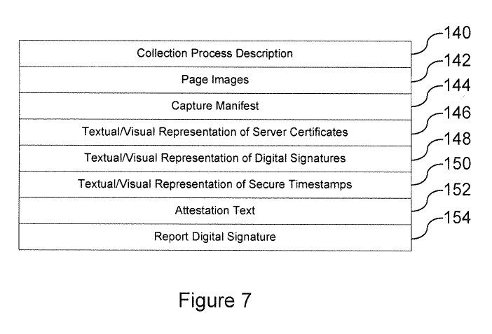

Ultimately, as indicated in FIG. 1, a capture result is generated (as will be further described in conjunction with FIG. 7 below) that is conveyed to the end-user. Using the above-described system and methodology detailed herein, an end-user has the ability to collect and capture evidence that appears on the Internet in a manner which is forensically sound. Such methodology preserves evidence that otherwise is transient since it is subject to change and/or deletion from a particular website. The application of the digital signature and digital timestamp, enable the end-user, or some interested third party, to verify the source and authenticity of the evidence.

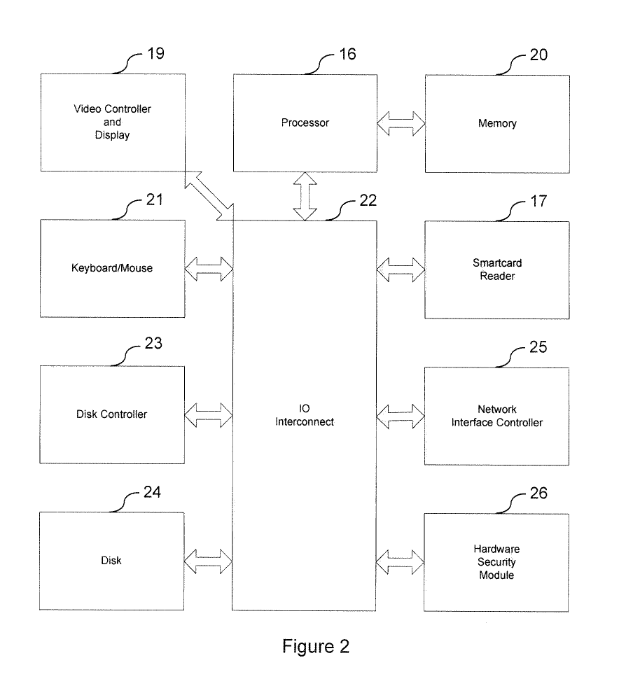

FIG. 2 is a block diagram of an illustrative implementation of the hardware associated with the evidence collection station 8 shown in FIG. 1. In the illustrative implementation, the evidence collection station 8 hardware may be, for example, a desk-top computer, implemented with any commercially available general purpose computer that is modified to additionally include a hardware security module 26 of the nature described below. By way of example only, Processor 16 may be a commercially available processor, such as an Intel CoreTM i7 series processor, that executes software of the nature described herein

The system includes a video controller/display module 19. The display module 19 is represented schematically as one unit but may comprise a microcontroller and a separate display that may, for example, be utilized by an analyst to view Internet content identified by the end user. It is contemplated that any of a wide range of commercially available display devices may be utilized including, for example, an LCD display.

The system includes keyboard/mouse 21 devices that are utilized by an analyst in the performance of certain forensic/clerical tasks. It is contemplated that any of a wide range of commercially available keyboard and mouse devices may be utilized including, for example, wired and wireless devices. It is also anticipated that the keyboard device might have integrated hardware to assist in the identification and authentication of the analyst prior to allowing the analyst access to the system, for example, a smartcard reader or fingerprint reader.

The system may include a Smartcard Reader 17 to assist in the identification and authentication of the analyst prior to allowing the analyst access to the system. In other, illustrative implementations this hardware may be omitted, present in the keyboard device, or replaced with biometric or other form of authentication mechanism.

Processor 16 is coupled to a disk controller 23 via the schematically represented bus system, to a disk controller 23 that manages reading from and writing to disk storage 24 in a manner well understood by those skilled in the art.

Processor 16 is directly coupled to system memory via an integrated memory controller. Processor 16 likewise is coupled to a network interface controller 25 via I/O interconnect 22 for controlling interconnection with the Internet to enable accessing target web server 10 shown in FIG. 1.

The evidence collection station 8 also includes a hardware security module 26. Hardware security module 26, in an illustrative embodiment, is utilized for secure storage of a private key utilized in public key cryptography operations. The degree of security provided by public key cryptography is a function of the degree of privacy in which the private key is held. The hardware security module 26 is a specialized card that securely stores the private key and performs required cryptographic operations. The hardware security module is designed to perform cryptographic operations such that the private key never appears external to the hardware security module. The hardware security module 26 is designed to store the key in an extremely secure environment. In other, illustrative implementations, this hardware may be omitted or replaced with a security module using a different private key storage mechanism, for example, a USB hardware token with key storage and cryptographic processing capabilities.

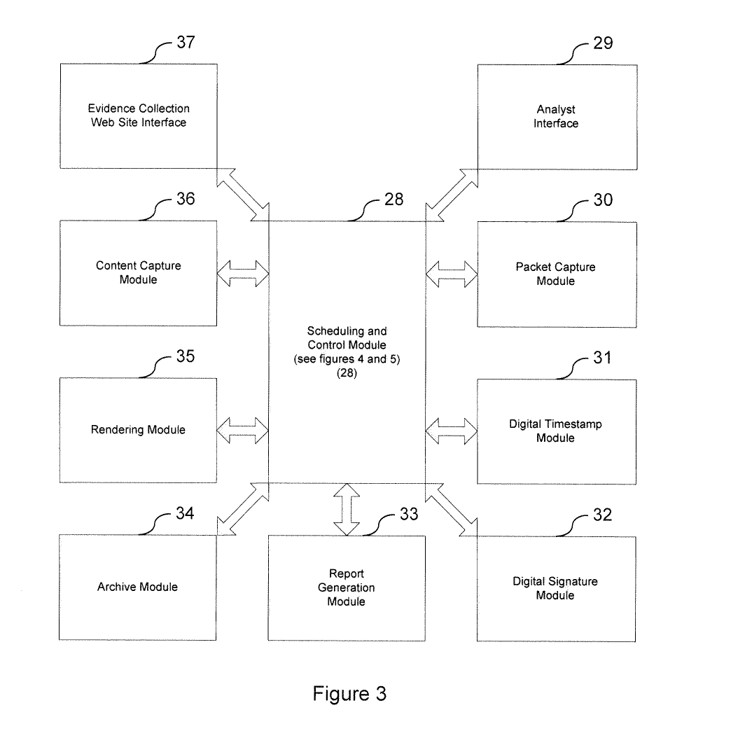

FIG. 3 is an illustrative block diagram of the evidence collection station functional/software architecture. The implementation of each of the modules shown in FIG. 3 will vary considerably depending upon the details of a given implementation. For example, an illustrative implementation may be a highly analyst-interactive implementation and will utilize an analyst interface 29. Alternatively, in another illustrative implementation, the evidence collection functionality may be totally automated, eliminating any analyst interaction. Further, a variety of implementations are contemplated using varying degrees of analyst interaction and automation.

In an analyst-intensive implementation, an end-user accesses the evidence collection website 6, shown in FIG. 1, and communicates a request including URLs and instructional information. The request may be sent to the collection station 8 in the form of an e-mail communication. In this implementation, the role of the evidence collection web site interface 37 is served by a standard e-mail client. An analyst may then check the e-mail and proceed to collect the above-described information from the webpage accessible via the specified URLs.

The analyst accomplishes his or her task using a standard web browser, for example, Google Chrome, Mozilla Firefox, or Microsoft Internet Explorer. Thus, the evidence collection station 8 receives URL and instruction information from the evidence collection web site 6 and includes a conventional software interface 37 for interacting with the Evidence Collection Website 6 shown in FIG. 1.

In an illustrative implementation, the analyst initiates the packet capture software to capture network packets. The packet capture module 30 operates to capture the network packet traffic between the evidence collection station 8 and the target web server 10. Such functionality is provided by off-the-shelf software as will be appreciated by those skilled in the art, for example, tcpdump and Wireshark.

In one illustrative implementation involving analyst interaction via analyst interface 29, the content capture module 36 is implemented by conventional browser technology. An analyst operating the evidence collection hardware 8 shown in FIG. 2 uses the computer's browser to access a desired target website 10. The analyst then views the webpage identified by the URL. The analyst then saves the rendered page as a PDF document, to thereby save an image of the page. The content capture module 36 also provides functionality for saving of the raw data. The analyst also saves the raw data associated with the page as will be further explained herein. The content capture module 36 may contain additional software that the analyst can use to capture content that cannot be accessed or saved from directly from the browser, for example, streaming audio and streaming video. Conventional software can be used for this purpose, for example, Concieva DownloadStudio and TechSmith Snaglt.

In an illustrative implementation, the content capture module 36 may capture Internet content delivered to desktop applications instead of a browser including Rich Internet Applications and Peer-to-Peer file sharing programs. In this implementation, the content capture module 36 will contain additional software to capture representations of the information presented in the application, for example, TechSmith SnagIt.

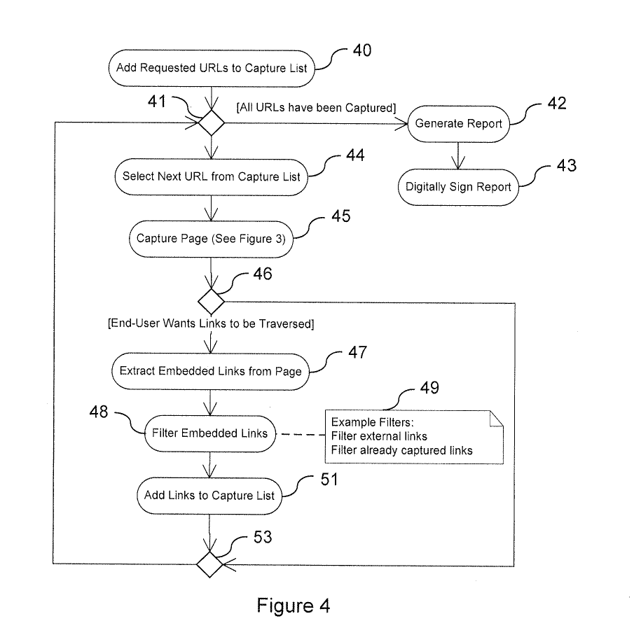

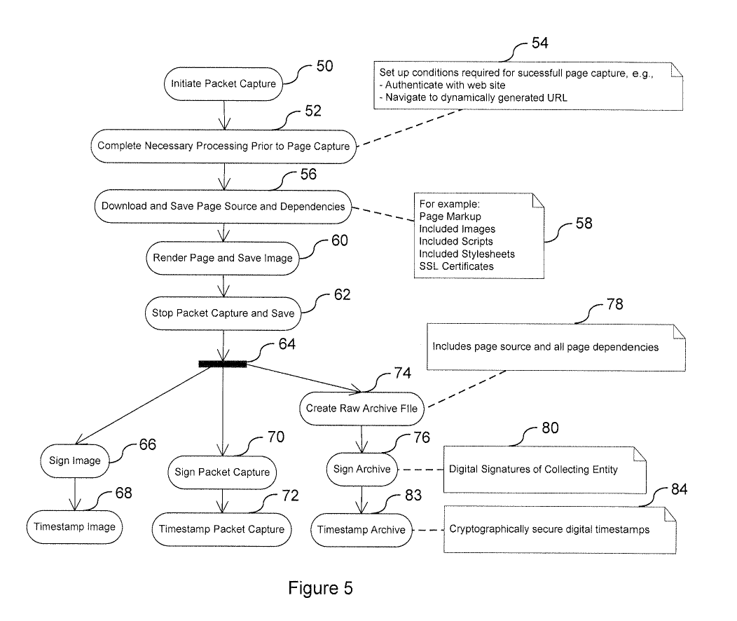

The scheduling and control module 28 implements the processing for capturing URLs requested by the end-user, as is explained further in conjunction with FIG. 4. In addition, the scheduling and control module 28 executes software for creating a page capture, as is explained further in conjunction with FIG. 5. In this implementation, the function of the scheduling and control module 28 is substantially met by the analyst from FIG. 1 following standard procedures that implement the processing described in FIGS. 4 and 5.

The rendering module 35 may likewise be part of a conventional browser. The browser downloads the HTML markup and renders it for display to the analyst. The rendering module 35, in addition to rendering content, permits downloaded content to be saved as a rendered image to a file.

In an illustrative implementation, once the analyst at the evidence collection station 8 has saved all appropriate content-related data, the analyst stops the packet capture. An archive module 34 is then used by the analyst to archive the captured raw information using, for example, WinZip.

A digital signature module 32 and digital time stamp module 31 are used by the analyst to digitally sign and digitally time stamp the captured information. The analyst may utilize the AbsoluteProof Sign and Seal product as the technology for both the digital signature and time stamp operations. The digital signature module and the digital time stamp module may be implemented by the methodology described in Surety LLC's U.S. Patent No. 7,047,404, which is incorporated herein by reference in its entirety. Using this methodology, the evidence is signed, revocation information corresponding to the signature certificate is obtained from the certificate authority 12, and the combination of the evidence, digital signature, certificate information, and revocation information is digitally time stamped. The result is a self-authenticating document that can be subsequently verified without requiring any additional information from the certificate authority. This process adds to the long-term forensic strength of the generated evidence.

In another illustrative implementation, instead of a digital signature and time stamp, the evidence might be protected by applying a secure hash algorithm or some other cryptographic function.

A report generation module 33 is then used by the analyst to generate a report by, for example, utilizing a Word-based template.

The generated evidence and the generated report are then transmitted to the end-user device 2 shown in FIG. 1. This transmission could be via an e-mail message.

In an illustrative implementation, the analyst may maintain a log of all steps performed in performing the capture.

In implementations where the system is totally automated without an analyst, the scheduling and control module 28 controls the entire collection process.

An end user accesses the evidence collection website 6, shown in FIG. 1, and communicates a request including URLs and instructional information, which is forwarded to the evidence collection website interface 37. This interface may be a REpresentational State Transfer (REST) style web services API. The user's request is then placed in a persistent work queue associated with the scheduling a control module 28.

At the appropriate time, scheduling and control module 28 accesses the user's request from the work queue. For each URL in the request, and for the URLs of any link on the target page that the instructional information indicate should be traversed, the scheduling and control module 28, directs the collection process.

The scheduling and control module 28 directs the packet capture module 30 to start capturing packet exchanges with the target web server 10. The packet capture module could be implemented with a conventional packet capture library, for example, libpcap.

The scheduling and control module 28 provides the URL to the content capture module 36, directs the content capture module 36 to retrieve the raw webpage data and save that data to disk. The content capture module 36 could be implemented directly or using third-party libraries for web, stream, and screen capture. Another illustrative implementation of fully automated content capture could use third party desktop products as mentioned in the analyst interaction implementation above, but control them via a scripting or automating interface.

The content capture module 36 connects to the target server 10 indicated by an end-user's identified URL to obtain an identified webpage and all its dependencies (as will be described in detail below). The content capture module 36 operates to access the webpage. As described herein, all desired information is saved.

The rendering module 35 is then utilized under the control of the scheduling and control module 28 to render the accessed page. The rendering module could be implemented using an open source rendering engine such as Mozille Gecko. The rendered page is then saved as, for example, a PDF file.

After the rendering module renders the webpage, the package capture module 30 is informed by the scheduling and controlling module 28 to cease capturing packets. Thereafter, the archive module 34 is utilized to combine the page markup and dependencies into an archive and stored such information in, for example, a zip file. The archive module could be implemented using an open source zip library such as Info-ZIP.

The digital signature module 32 is utilized to digitally sign the image, the packets and the raw data. This module could be implemented using one of many available cryptographic libraries, for example, Bouncy Castle. Additionally, each type of information is digitally time stamped by the digital time stamp module 31. As noted above, such digital time stamp module 31 may, for example, be implemented using the linked token method implemented in Surety LLC's AbsoluteProof Service. This module could be implemented using the AbsoluteProof Software Development Kit. Furthermore, as mentioned above the digital signatures and digital timestamp could be combined using the methodology described in Surety LLC's U.S. Pat. No. 7,047,404. The report generated by report generation module 33 is then digitally signed. This module could be implemented using any of a wide range of report generation libraries.

In an illustrative implementation, the scheduling and control module 28 may maintain a log of all steps taken in performing the evidence collection process.

The FIGS. 4 and 5 flowcharts described below are presented in a UML activity diagram format as will be understood by those skilled in the art.

FIG. 4 delineates the sequence of operations performed by the scheduling and control module 28 in capturing the requested URL's. The scheduling and control module 28 shown in FIG. 3, in performing the capturing of requested URL's, adds the URLs requested by the end-user to a stored capture list (40). In an illustrative implementation, if the end-user identified instructions that must be deciphered in order to determine a URL, the analyst deciphers the instructions and converts the instruction to a URL. Thus, for example, an analyst may access a webpage by reviewing instructions which include the identification of a user ID and password.

The capturing requested URL routine then checks to determine whether all URLs are captured (41). If so, a report is generated (42) as will be explained further below and the report is digitally signed (43). The generated report is digitally signed to reliably associate it with the issuer of the report and to prevent the report from being nefariously changed after the report has been issued.

If all URLs are not captured, the routine selects the next URL from the capture list (44).

Thereafter, the webpage corresponding to the URL is captured (45) in a manner which is explained in detail below, in conjunction with the description of FIG. 5.

After a webpage has been captured, a determination is made as to whether the links embedded in the page should be followed (46). In this fashion, a determination is made as to whether webpage links should be followed to completely traverse the website accessed. The decision as to whether links should be traversed may be made in conjunction with instructions received from the end user or be based upon the independent judgment of the analyst or criteria analyzed by a fully automated scheduling and control routine.

For example, if instructions conveyed by the end user indicated that links should be followed, then the routine extracts embedded links from the page (47). In an automated implementation, the links are identified by an identifiable HTML anchor, A, tag that identifies, among other things, the target location of the displayed link.

After the embedded links are extracted from the page, the links are appropriately filtered (48). In an illustrative implementation, an end user may specify that the links followed should be limited to links internal to the website. Accordingly, an illustrative filter would filter out links to external sites (49). Additionally, the filter may operate in an illustrative implement to reduce redundancies. Thus, the routine may operate to filter out repeatedly identified links to already captured content. For example, multiple pages at a website may each have links to the same webpage.

After the embedded links are appropriately filtered (48), the filtered links are added to the capture list (51) to identify the further tasks to be completed. After the processing relating to adding links to the capture list (51), or if the determination at decision block 46 is not to follow the link options, the routine sequences, as represented by block 53, back to decision block 41, which determines whether all URLs have now been captured.

Thereafter, the capturing of a requested URL process continues until all URLs are captured, whereby the report is generated and digitally signed (42 and 43) and the routine concludes processing.

FIG. 5 is a flowchart further depicting the processing performed by the scheduling and control module 28 shown in FIG. 3 that details the processing involved in the capturing of a page. Such processing is performed in the capturing the requested URL routine shown in FIG. 4 at block 45.

The routine depicted in FIG. 5 involving the page capture process is designed to enhance the forensic soundness of the information captured. In this fashion, the capturing process is designed to provide strong evidence establishing that the information that was captured was, in fact, provided on the identified website. Various diverse forms of evidence are captured in order to more convincingly establish what was published and that the captured information accurately represents the content that appeared on the webpage.

In accordance with an illustrative implementation shown in FIG. 5, the information is captured in three different ways. In this fashion, it is established that the identified information did, in fact, appear on the website at the point in time when the capture was made. In order to accomplish this, the first form of information captured in this illustration is the image of the webpage as may, for example, be embodied in an a webpage screen shot or by saving the page as a PDF image.

The second form of information captured is information utilized to generate the page image, such as the underlying HTML markup, image files, stylesheets, scripts, multimedia applications (for example, Flash and Silverlight applications), and other information utilized to create the webpage image or experience. Such underlying information is extracted from the accessed website. The information captured will also include SSL certificates for any servers where information was retrieved via HTTPS.

In cases where the resource corresponding to the URL is not a webpage, then the native representation of that resource is saved, for example, an MP3 file for an audio resource, a PNG file for an image resource, MP4 file for video, PDF file for a document.

Additionally, the system captures the network traffic exchanged between the content capture module 36 and the target website. The communicated data is a representation of the webpage as it appeared “on the wire”. The capture information includes not only the high-level page elements mentioned above, but low-level protocol elements that may be useful in establishing the authenticity of the information, for example, TCP/IP packets, HTTP headers, TCP sequence numbers, SSL negotiation information. As will be appreciated by those skilled in the art, SSL is an acronym for secure socket layer that ensures secure connections between websites.

Turing to FIG. 5, the page capture process begins by initiating packet capture (50) to thereby initiate capturing information exchanged between the target website and the collection station content capture module 36. Thereafter, processing that needs to be performed prior to page capture is completed prior to page capture (52). In this fashion, the routine sets the stage for successful page capture, which may, for example, involve authenticating the end-user with the target website (54). Thus, if a user needs to complete log-in processing, such steps are taken. Alternatively, if a number of accessing steps need to be accomplished to get, for example, to a desired Facebook Wall, such steps are taken. These steps may include completing the processing required to dynamically generate necessary URL's to appropriately navigate to access the target content. Depending upon the implementation, such processing to set up conditions for successful page capture may be automated and in alternative implementations, an analyst may take any steps necessary for desired page capture.

Thereafter, the system downloads and saves a page source and all its dependencies (56). As used herein, the term “dependencies” refers to all information that is needed to display a page. Such dependencies may, for example, include the page markup, included images, included scripts, included stylesheets, multimedia applications (for example, Flash and Silverlight applications), and SSL certificates (58) associated with a secure site. Accordingly, all the information that is utilized in displaying a page is recorded.

The page is then rendered and saved (60). In an illustrative embodiment, the page rendering may be accomplished by accessing the page via a browser by an analyst and the analyst may save a PDF image of the page. Alternatively, the routine may automatically render and save the page. After the image has been rendered, the routine stops the packet capture process and saves the packet capture (62). In this fashion, the entirety of the exchange between the collection site browser and the target web server that led to the display of the desired page is captured.

As indicated by block 64, the capture-related operations that follow may be performed in any desired order or in parallel in certain implementations. As shown in FIG. 5, the routine operates to sign the image (66) and time stamp the image (68). The signed image provides proof that the signer collected the image. The signature may be, in an exemplary implementation, signed by the evidence collection station operator (see the evidence collection system 4 and the evidence collection station 8 shown in FIG. 1). The methodology used to sign and time stamp the image was previously described in the description of FIG. 3.

Additionally, the packet capture that was saved at 62 is digitally signed (70) and is digitally time stamped (72).

Additionally, the system creates a raw archive file (74) of the page source and dependencies shown in 56 and 58 above. The created raw archive that includes a page source and all page dependencies (78) may be, for example, stored in a zip file. Thereafter, the archive is signed (76) utilizing of the private key and digital certificate of the collecting entity operating the evidence collection website 6 (80). The archive is then digitally time stamped (82) utilizing a cryptographically secure digital time stamp (84).

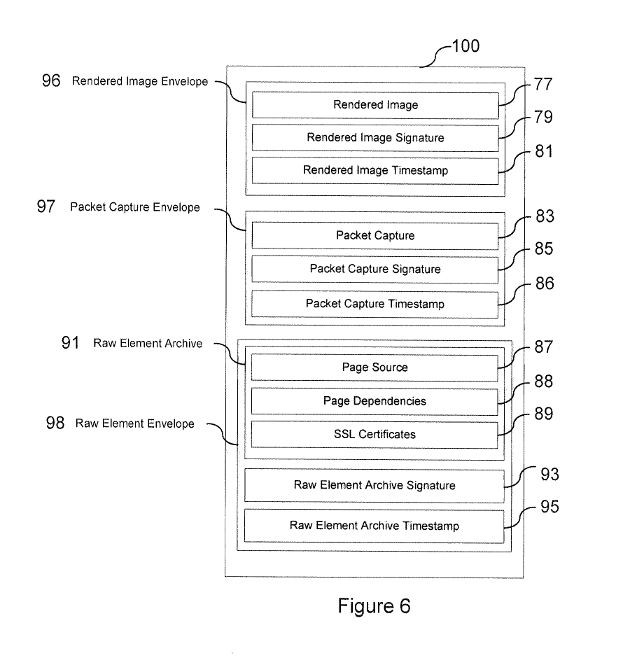

FIG. 6 is an illustration of the structure of a webpage capture that may, for example, be stored in a file(s) 100 that may be a zip file(s). The files 100 may be stored on disk 24 shown in FIG. 2. As shown in FIG. 6, within files 100 there is a rendered image envelope 96 file which is an archive file containing a rendered image 77, a rendered image signature 79 and a rendered image digital time stamp 81.

Additionally, a further file within file 100 is the packet capture envelope 97, and is comprised of packet capture-related information including the packet capture 83, the packet capture signature 85 and the packet capture time stamp 86.

As shown in FIG. 6, file 100 also includes a further page capture file in the form of a raw element archive 91. The raw element archive is a zip file that includes a page source 87 that includes the original HTML markup of the page, page dependencies 88 and SSL certificates 89. Additionally, the raw element archive digital signature 93, and raw element archive digital time stamp 95, may be contained in a raw element envelope 98, which is another zip file.

FIG. 7 is an illustration of the capture report components. In an illustrative implementation, the capture report includes a description of the collection process 140. This description may describe capture methodology and why it is forensically sound. After the presentation of a collection process description, the report will include renditions of the actual page images (142) to visually depict the content that triggered the process described herein. Such page images will include all relevant images the number of which will vary depending upon the given application.

The report capture manifest section 144 will include a description of the contents of the webpage capture 100. In this fashion, a listing in the form of a table of contents of the collected evidence is presented. This may also contain a description of how someone may view the evidence in the webpage capture and validate the contained digital signature and time stamps.

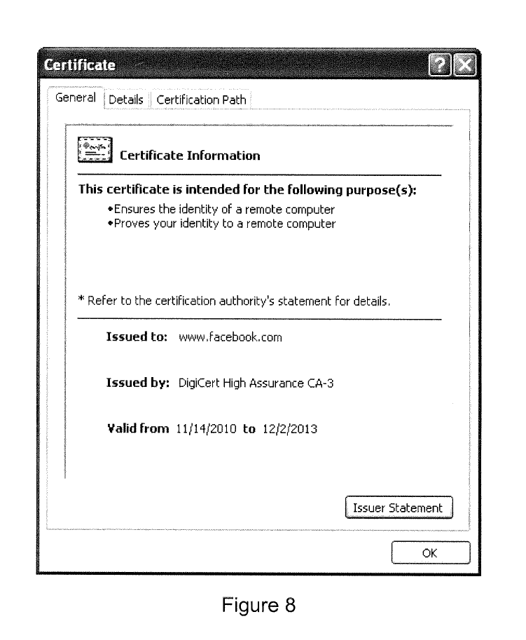

The report will also include a textual description of the server certificates 146 if any. Thus, a textual description of the server certificate may identify the website that was captured, e.g. www.facebook.com, and that the certificate was issued by certificate authority on a particular date. The server certificate may be visually represented in an illustrative embodiment. FIG. 8 shows an illustrative visual representation of a server certificate in the form of a screenshot.

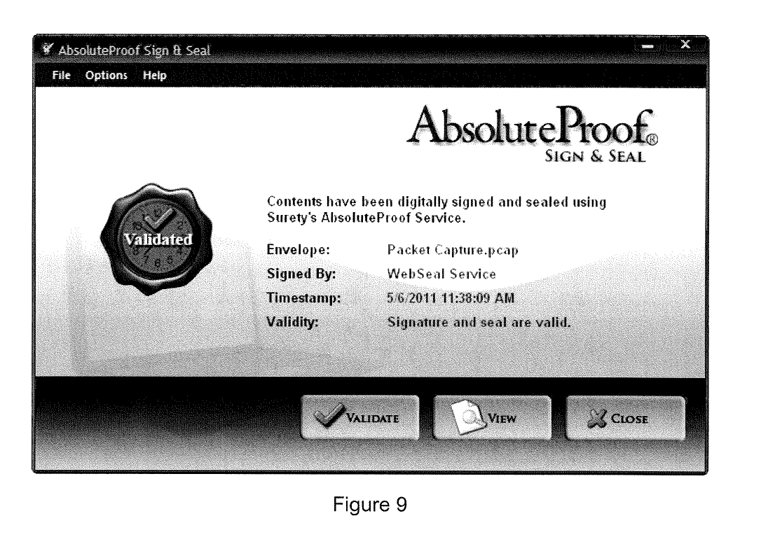

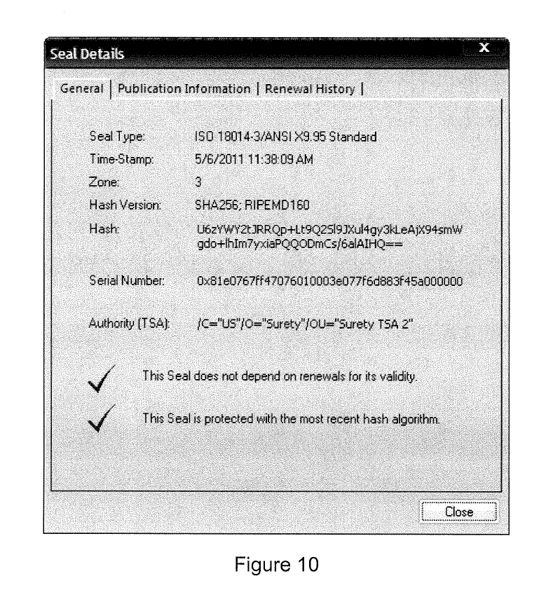

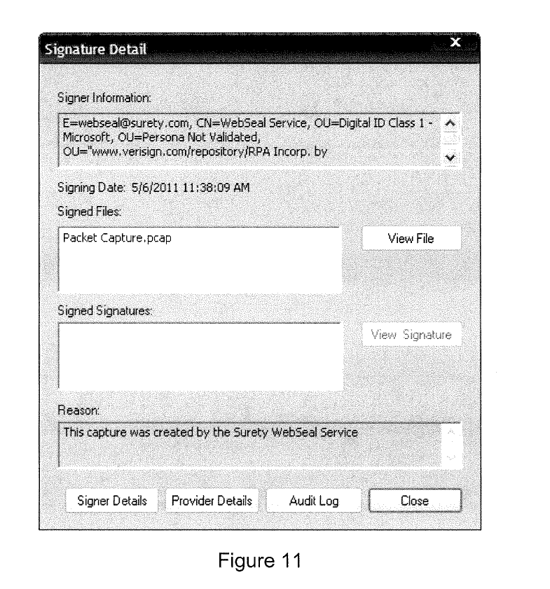

Additionally, the report will include a representation of digital signatures 148 and a representation of the secure digital time stamp 150. In an illustrative implementation, the representations of the digital signature and digital time stamps 148 and 150 may be a visual representation of the digital signature and digital time stamp in the form of a screen capture. FIG. 9 depicts a screen capture from the AbsoluteProof Sign and Seal application indicating that both the signature and time stamp are valid. FIGS. 10 and 11 are an illustrative visual representation of a digital signature and time stamp, respectively in the form of a screen capture from the AbsoluteProof Sign and Seal application.

The report may also include an attestation text section 152 that identifies, for example, the entity that generated the report and the process utilized in the analysis. A report digital signature 154 is appended so that it can be established that the report was generated by the collecting agent.

The above description is provided in relation to embodiments which may share common characteristics, features, etc. It is to be understood that one or more features of any embodiment may be combinable with one or more features of other embodiments. In addition, single features or a combination of features may constitute an additional embodiment(s).

While the invention has been described in connection with what is presently considered to be the preferred embodiment(s), it is to be understood that the invention is not to be limited to the disclosed embodiment(s), but on the contrary, is intended to cover various modifications and equivalent arrangements included within the spirit and scope of the claims.

1. A web data collection system comprising:
a first interface configured to accept resource capture requests from at least one end-user and to transmit at least one capture result to the end-user, said at least one capture result including a representation of a web resource having at least one cryptographic function applied to the representation;
a second interface configured to access at least one web resource from at least one remote website accessible based upon information in said capture request received from said at least one end-user; and
a collection processing system configured to receive at least one capture request from said first interface and to use the second interface to connect to a remote website over a communications network and obtains at least one representation of at least one web resource, said collection processing system being configured to apply at least one cryptographic function to the at least one representation of a web resource, and to provide to the first interface a capture result comprising the at least one representation of a web resource with the at least one cryptographic function applied to the representation.

2. The web data collection system of claim 1, where the cryptographic function is secure hash algorithm.

3. The web data collection system of claim 1, where the cryptographic function is a digital signature.

4. The web data collection system of claim 1, where the cryptographic function is a secure time stamp.

5. The web data collection system of claim 1, where the cryptographic function is a combination of at least one digital signature and at least one secure time stamp.

6. The web data collection system of claim 1, where the at least one representation includes an image of the at least one web resource as it would be rendered to the user.

7. The web data collection system of claim 1, where the at least one representation includes a raw component resource that is used to render the at least one web resource to the user.

8. The web data collection system of claim 1, wherein the at least one representation includes a webpage image and a raw component that is used to render the at least one web resource to the user.

9. The web data collection system of claim 1, where the at least one representation includes an audio file that would be played for the user.

10. The web data collection system of claim 1, where the at least one representation includes a video file that would be displayed for the user.

11. The web data collection system of claim 1, where the second interface is configured to access the at least one resource using the HTTP protocol.

12. The web data collection system of claim 1, where the second interface is configured to access the at least one resource using the HTTPS protocol.

13. The web data collection system of claim 1, where the collection processor system is configured to maintain a log of steps taken.

14. The web data collection system of claim 1, where the collection processing system is configured to details of how the at least one representation of the web resources was obtained.

15. The web data collection system of claim 1, where the capture result includes at least on written report summarizing what was collected and the capture process.

16. The web data collection system of claim 1, where the web data collection system is run by third party that is independent of the party requesting the capture.

17. A web-based evidence collection system comprising:
a first interface configured to accept evidence capture requests from at least one end-user and to transmit at least one capture result to the end-user of a representation of a web resource containing the evidence having at least cryptographic function applied to the representation;
a second interface configured to access at least one web resource from at least one remote website accessible based upon information in said evidence capture request received from said at least one end-user; and
a collection processing system configured to receive at least one evidence capture request from said first interface and to use the second interface to connect to a remote website over a communications network and obtains at least one representation of at least one web resource containing the evidence, said collection processing system including a security module storing at least one private key, said processing system being configured to apply at least one cryptographic function using said private key to the at least one representation of a web resource, and to provide to the first interface a capture result comprising the at least one representation of a web resource with the at least on cryptographic function applied.

18. The web data collection system of claim 17, where the cryptographic function is a combination of at least one digital signature and at least one secure time stamp.

19. The web data collection system of claim 17, where the at least one representation includes an image of the at least one web resource as it would be rendered to the user.

20. The web data collection system of claim 17, where the at least one representation includes a raw component resource that is used to render the at least one web resource to the user.

21. The web data collection of claim 17, wherein the at least one representation includes a webpage image and a raw component that is used to render the at least one web resource to the user.

22. The web data collection system of claim 17, where the at least one representation includes an audio file that would be played for the user.

23. The web data collection system of claim 17, where the at least one representation includes a video file that would be displayed for the user.

24. A web data collection method comprising the steps of:
receiving at least one resource capture request from at least one end-user;
connecting to a remote website over a communications network based upon information in said capture request received from said at least one end-user;
obtaining at least one representation of at least one web resource based upon information in said capture request received from said at least one end-user,
applying at least one cryptographic function to the at least one representation of a web resource, and
transmitting at least one capture result to the end-user of a representation of a web resource having at least cryptographic function applied to the representation.

25. The web data collection method of claim 24, where the cryptographic function is secure hash algorithm.

26. The web data collection method of claim 24, where the cryptographic function is a digital signature.

27. The web data collection method of claim 24, where the cryptographic function is a secure time stamp.

28. The web data collection method of claim 24, where the cryptographic function is a combination of at least one digital signature and at least one secure time stamp.

29. The web data collection method of claim 24, where the at least one representation includes an image of the at least one web resource as it would be rendered to the user.

30. The web data collection method of claim 24, where the at least one representation includes a raw component resource that is used to render the at least one web resource to the user.

31. The web data collection method of claim 30, wherein the at least one raw component resource includes a script that affects the behavior of the page.

32. The web data collection method of claim 24, where the at least one representation includes an audio file that would be played for the user.

33. The web data collection method of claim 24, where the at least one representation includes a video file that would be displayed for the user.

34. The web data collection method of claim 24, where the step of obtaining includes the step of using the HTTP protocol.

35. The web data collection method of claim 24, where the step of obtaining includes the step of using the HTTPS protocol.

36. The web data collection method of claim 24, further including the step of maintaining a log of processing steps taken during the obtaining step.

37. The web data collection method of claim 1, further including the step of providing details as to how the at least one representation of the web resources was obtained.

38. The web data collection method of claim 24, further including the step of generating a written report summarizing what was collected and the capture process.

39. The web data collection method of claim 24, wherein the web data collection is run by third party that is independent of the party requesting the capture.

40. The web data collection method of claim 24, wherein the web data collection is fully automated.

41. The web data collection of claim 7, wherein the at least one raw component resource includes an image that is depicted in the display of the resource to the user.

42. The web data collection of claim 20, wherein the at least one raw component resource includes an image that is depicted in the display of the resource to the user.

43. The web data collection of claim 30, wherein the at least one raw component resource includes an image that is depicted in the display of the resource to the user.

44. The web data collection system of claim 5, where the at least one digital signature and the at least one digital time stamp are combined in the form of a self-authenticating document.

45. The web data collection system of claim 18, where the at least one digital signature and the at least one digital time stamp are combined in the form of a self-authenticating document.

46. The web data collection system of claim 28, where the at least one digital signature and the at least one digital time stamp are combined in the form of a self-authenticating document.
